(19) United States
(12) Patent Application Publication
(10) Pub. No.: US 2005/0284461 A1
(43) Pub. Date: Dec. 29, 2005

(54) Far-infrared barbecue device

(76) Inventor: Sen-Kung Hsu, Shu-Lin City (TW)

Correspondence Address: BIRCH STEWART KOLASCH & BIRCH, PO BOX 747, FALLS CHURCH, VA, 22040-0747, US

(21) Appl. No.: 10/876,471

(22) Filed: Jun. 28, 2004

(51) Int. Cl. F24C 3/00; A47J 37/00

(52) U.S. Cl. 126/41 R; 99/444

(57) ABSTRACT

A far-infrared barbecue device includes a body having four sidewalls so as to form a barbecue area and a gas burner is transversely installed in the barbecue area. A plurality of support frames is located at an inner bottom of the barbecue area and the gas burner is located between the support frames. A plurality of far-infrared ceramic boards stand between the support frames and located above the gas burner. A food rack composed of a plurality of ceramic bars is installed above the far-infrared ceramic boards so that food is cooked by the far-infrared energy and maintains its flavor and nutrition. The food rack has non-stick surface and are durable high temperature and easily to be cleaned.

### FIELD OF THE INVENTION

The present invention relates to an environment-friendly far-infrared barbecue device, especially for a barbecue device composed of a quickly-installed far-infrared ceramic board located above a gas burner, such as a metal-tube gas burner and a honeycomb shaped ceramic burner, a support frame for dispensing grease and air, and ceramic bars that are high temperature durable. The barbecue device is easy to clean and is environment-friendly.

### BACKGROUND OF THE INVENTION

Applicant has years of experience of studying cooking wares and burners and knows that the conventional barbecue device has the following shortcomings so that the novelty barbecue device using a far-infrared board is developed. The conventional outdoor barbecue devices in the market generally includes a hollow body and flammable material such as charcoal or gas burner is installed at the bottom of the body so as to generate heat to cook the food. On the burner, fire-durable bricks or volcano rocks are located so as to disperse the heat and a metal netted member such as steel or casting iron netted member is put on the fire-durable bricks or volcano rocks so that food can be put on the netted member to be cooked by the heat generated by the burner. The conventional barbecue device has the following shortcomings:

(1) The charcoal or the gas is burned to generate heat which is dispensed via the fire-durable bricks, volcano rocks, or metal boards to cook the food. The heat of energy is not transferred into far-infrared energy and is called visible direct heat energy that is used to directly cook the food. The heat is not evenly applied to the food, which is easily dehydrated, over burning so that the nutrition of the food is destroyed and the taste of the food is awkward.

(2) The gas or the charcoal is not burned completely and the incompletely burned smoke contaminates the food. In order to avoid over burning, fire-durable bricks, volcano rocks, or metal boards are used to dispense the heat. However, these materials include multiple tiny holes that trap the grease and juice from the food and are difficult to clean. When they are used again, the grease and the juice become harmful gas after being treated by high temperature and the harmful gas ruins the taste the food and causes damage to the people's health.

(3) The metal-netted member becomes black and is coated with carbon debris due to the food debris, juice, and grease heated continuously. The netted member has to be replaced frequently.

(4) The grease or juice of food or the barbecue sauce drops on the metal made gas burner and is heated and becomes black and hard carbonized spots which are difficult to be cleaned and could shorten the lift of use of the gas burner.

The applicant has years of experience of studying cooking wares and burners and knows that the conventional barbecue device has the above-mentioned shortcomings. The barbecue device of the present invention is done to improve the shortcomings of the conventional barbecue device.

### SUMMARY OF THE INVENTION

The present invention is to provide a far-infrared barbecue device that includes a body with at least one gas burner installed therein which is positioned by support frames and far-infrared ceramic boards are put above the gas burner. The far-infrared ceramic boards includes wave-shaped surface in the inner layer thereof so as to increase the area for absorbing heat such that the heat energy coming from the gas burner may be trapped in the concavities of the surface temporarily and can be burned again so as to increase the efficiency of burning and shorten the barbecue time required. The food is separated by the ceramic boards and is not contaminated by the gas. By the far-infrared ceramic boards, the heat energy of the gas can be transferred into far-infrared energy which cook the foods by the features of absorbing, emitting, penetrating and vibrating so that the food is evenly cooked and maintains juicy and nutritious. Even a thick piece of meat can be treated to be tender and juicy and maintains its flavor. All the germs in the meat are killed and no unhealthy substance is remained.

The far-infrared barbecue device of the present invention uses far-infrared ceramic boards and a plurality of food rack composed of ceramic bars or nano ceramic glaze and non-stick surface metal bars. The bars has smooth outer surface on which food does not stick and does not get rust, or oxidized so that the food is not contaminated. The bars are easily to clean and disengaged from the barbecue device. The bars can be soaked and cleaned one by one so that the food rack does not need to be replaced frequently.

The gas burner of the barbecue device of present invention may transfer the heat energy into far-infrared energy by the support frames for dispensing grease and air, and the far-infrared boards located above the burner. The gas burner is protected from being attached by the food juice or grease or the sauce. The grease is guided into a plate so that the grease is separated form the flames can will not get fire. The heat air is dispensed from the apertures of the support frames.

The present invention will become more obvious from the following description when taken in connection with the accompanying drawings, which show, for purposes of illustration only, a preferred embodiment in accordance with the present invention.

### BRIEF DESCRIPTION OF THE DRAWINGS

FIG. 1 is an exploded view of a far-infrared barbecue device in accordance with the present invention;

FIG. 2 is a perspective view showing a far-infrared ceramic board in accordance with the present invention;

FIG. 3 is a perspective view, observed from bottom side, showing the far-infrared ceramic board of the present invention;

FIG. 4 is a perspective view showing a support board of the present invention;

FIG. 5 is a perspective view, observed from bottom side, showing the support board of the present invention;

FIG. 6 is an exploded view showing a food rack of the present invention;

FIG. 7 is a perspective view of the food rack of the present invention;

FIG. 8 shows a windshield connected to the barbecue device of the present invention;

FIG. 9 shows a hood mounted to the windshield of the present invention, and

FIG. 10 shows the barbecue device put on a cabinet.

### DETAILED DESCRIPTION OF THE PREFERRED EMBODIMENT

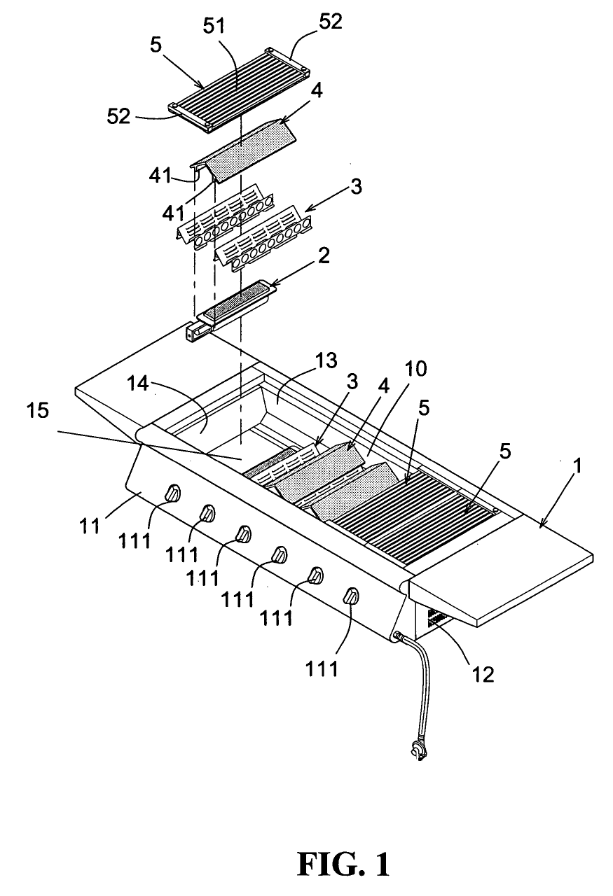

Referring to the drawings and in particular FIGS. 1-10, a far-infrared barbecue device of the present invention comprises a body 1 with four sidewalls 11, 12, 13, 14 so as to enclose a barbecue area 10. The front sidewall 11 has at least one gas switch 111. A gas burner 2 is transversely installed in the barbecue area 10 and connected to the gas switch 111. A plurality of support frames 3 is located at an inner bottom of the barbecue area 10 and the gas burner 2 is located between the support frames 3. The support frames 3 each include apertures 3a that guides grease from food into a plate 15, and slots 3b that dispense hot air upward through the slots 3b. Far-infrared ceramic boards 4 each include two flanges 41 standing between the support frames 3 and are located above the gas burner 2. A food rack 5 is composed of a plurality of ceramic bars 51 or nano ceramic glaze and non-stick metal bars, the ceramic bars 51 are durable for high temperature. Two ends of each ceramic bars 51 are fixed by two sets of clamping devices 52 so as to be firmly positioned between the two sidewalls 11, 13 and located above the far-infrared ceramic boards 4. A windshield 6 is installed around the barbecue area 10 and a plurality of notches 611, 621 are defined in two opposite side panels 61, 62 such that skewers 60 can be engaged with the notches 611, 612.

The far-infrared ceramic boards 4 used in the barbecue device of the present invention may use the material disclosed in Taiwanese Patent Application No. 86106520 and U.S. Pat. No. 6,261,985 B1, but is not limited thereto. The far-infrared ceramic boards 4, support frames 3 and food rack 5 are made by the patented material as disclosed above and treated by the latest nano ceramic glaze and non-stick treatment so that they are easily to clean and not to be contaminated.

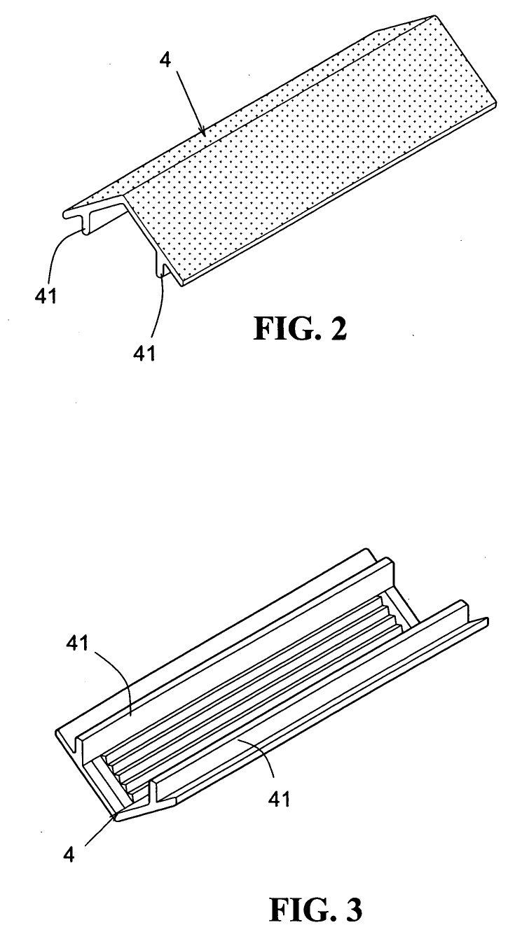

As shown in FIGS. 2 and 3, the far-infrared ceramic boards 4 used in the barbecue device of the present invention each have a V-shaped cross section and the two flanges 41 extend from bottoms of two respective wings thereof. The two flanges 41 stand across tops of outsides of the support frames 3 and position the far-infrared ceramic boards 4 so as to prevent the far-infrared ceramic boards 4 from slipping downward from the support frames 3.

The support frames 3 used in the barbecue device of the present invention have the apertures 3a for guiding the grease from the food into a plate 15, and the slots 3b for releasing the hot air upward through the slots 3b.

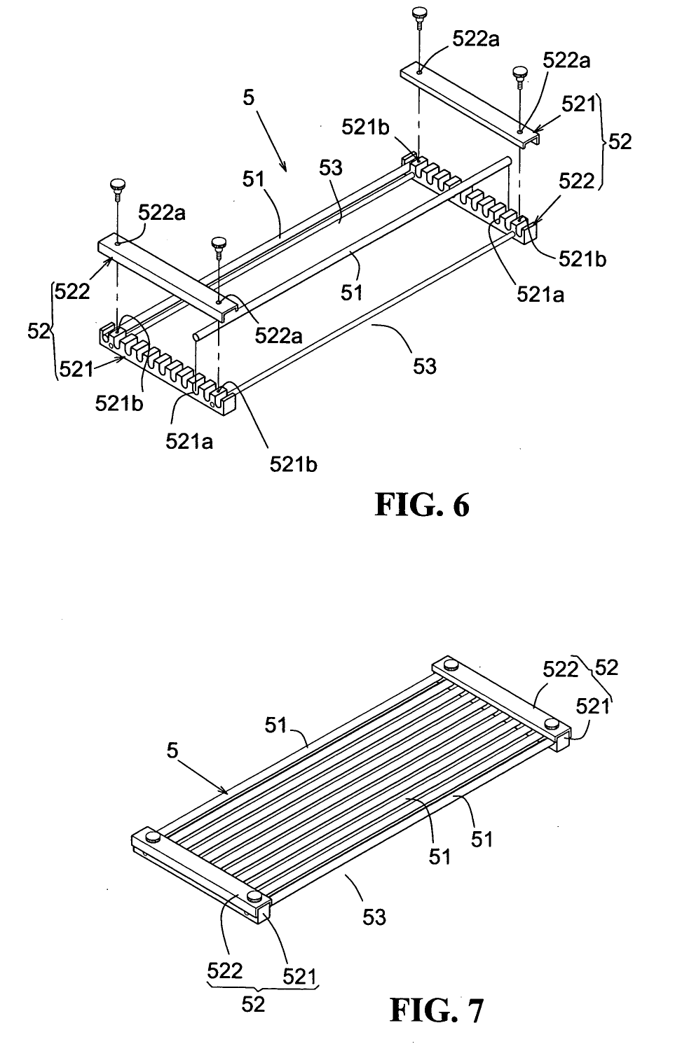

The food rack 5 of the barbecue device of the present invention, as shown in FIGS. 6 and 7, is composed of several ceramic bars 51 and two sets of clamping devices 52. Each set of the clamping device 52 includes a base 521 that includes a plurality of recesses 521a so as to respectively receive an end of a ceramic bar 51. A plurality of threaded holes 521b is defined in the base 521. A top board 522 is mounted on each of the bases 521 and has through holes 522a so that bolts extend through the through holes 522a and are connected in the threaded holes 521b to clamp and position the ceramic bares 51.

The food rack 5 of the barbecue device of the present invention, as shown in FIGS. 6 and 7, two connection rods 53 are connected between the clamping devices 52 to which the two ends of the ceramic bars 51 are connected so as to connect the tow clamping devices 52.

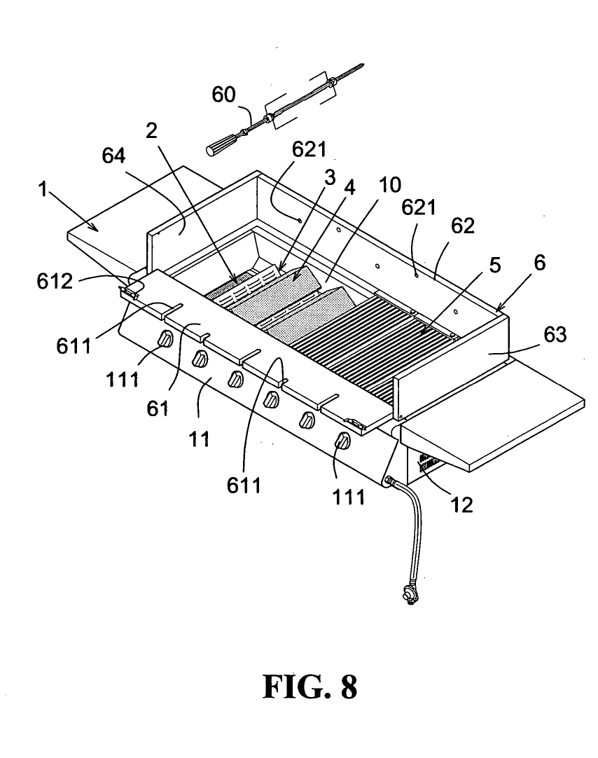

The windshield 6 of the barbecue device of the present invention, as shown in FIG. 8, includes the first side panel, the second side panel, the third side panel and the fourth side panel 61, 62, 63 and 64. The second, the third and the fourth side panels 62, 63 and 64 are connected as an integral piece and the two ends of the first side panel 61 are pivotally connected between the third and the fourth side panels 63, 64, so that the first side panel 61 can be pivoted outward. The first side panel 61 has a latch bolt 611 located at one of two ends thereof so as to be secured to the third or the fourth side panels 63 or 64. By this way, the first, the second, the third and the fourth side panels 61, 62, 63 and 64 encloses around the barbecue area 10.

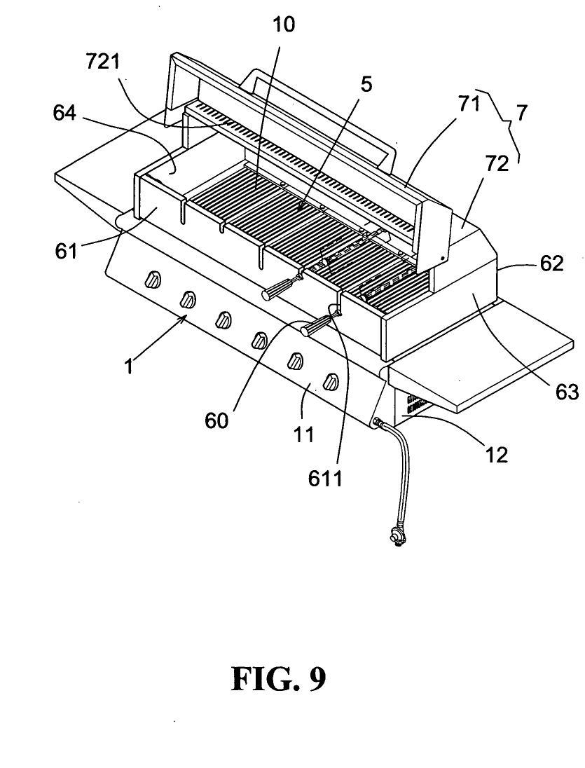

The barbecue device of the present invention, as shown in FIG. 9, includes a hood 7 which includes a front hood 71 mounted onto a front part of the windshield 6, and a rear hood 72 which has one side pivotally connected to the front hood 71 so as to be pivotally mounted to a rear part of the shield 6 such that the barbecue area 10 can be enclosed by the hood 7. Of course, the hood 7 may also be connected to the periphery of the barbecue area 10 of the barbecue device.

The rear hood 72 includes a row of ventilation holes 721 which can be connected to a pipe so as to collect the smokes to a desired place to be treated.

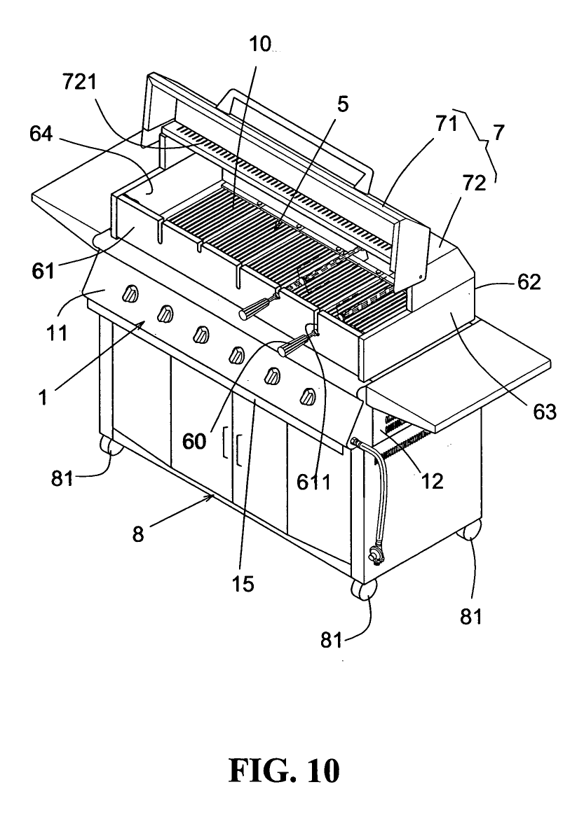

The barbecue device of the present invention, as shown in FIG. 10, includes a cabinet 8 fixed to the bottom of the body 1 and a plurality of casters 81 are connected to the underside of the cabinet 8 for conveniently moving the cabinet 8.

The barbecue device of the present invention includes the following advantages and features:

(1) The far-infrared boards 4 are installed across the support frames 3 and have non-stick surface and are easily to be installed and cleaned.

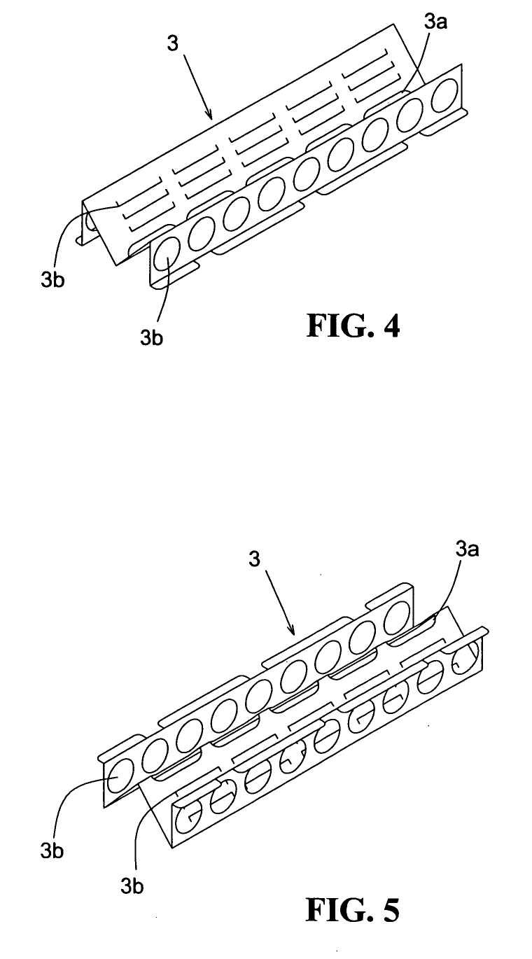

(2) The support frames 3 as disclosed in FIGS. 4 and 5 support the far-infrared boards 4 and guide the grease to the plate so as to prevent the grease from get fire. The slots 3b dispense the hot air upward from the barbecue device.

(3) The two ends of the ceramic rods 51 of the food rack 5 are clamped by two sets of the clamping device 52 such that the whole food rack 5 including the ceramic bars 51 can be disengaged from the barbecue device conveniently and the bars 51 are easily to be cleaned. The bars 51 are clamped in position and do not roll.

(4) The barbecue device may install the windshield 6 or the hood 7 so as to increase the functions of the barbecue device. Skewers 60 can be engaged between the fist and the second side panels 61, 62 of the windshield 6 so as to treat the food penetrated by the skewers 60. The hood 7 is used to cover up the barbecue area 10 to treat the food by the hot air enclosed by the hood 7.

(5) The hood may have a row of ventilation holes 721 for ventilating the smokes during barbecue.

While we have shown and described the embodiment in accordance with the present invention, it should be clear to those skilled in the art that further embodiments may be made without departing from the scope of the present invention.

1. A far-infrared barbecue device comprising:
a body having four sidewalls so as to enclose a barbecue area, one of the sidewalls having at least one gas switch, and
a gas burner transversely installed in the barbecue area and connected to the gas switch, a plurality of support frames located at an inner bottom of the barbecue area and the gas burner located between the support frames, a plurality of far-infrared ceramic boards standing between the support frames and located above the gas burner, a food rack composed of a plurality of ceramic bars and two ends of each ceramic bars being fixed by two sets of clamping devices so as to be firmly positioned between the two sidewalls.

2. The device as claimed in claim 1, wherein a windshield is installed around the barbecue area and a plurality of notches is defined in two opposite side panels of the windshield, skewers engaged with the notches.

3. The device as claimed in claim 1, wherein the far-infrared ceramic boards each have a V-shaped cross section and the two flanges extend from bottoms of two respective wings thereof, an outer surface of the far-infrared ceramic boards being treated by nano ceramic glaze and non-stick surface, the two flanges preventing leakage of heat energy and an outer surface being in contact with the support frames so as to prevent the far-infrared ceramic boards from slipping downward from the support frames, each support frame having the apertures for guiding the grease from the food into a plate, and the slots for releasing the hot air upward through the slots.

4. The device as claimed in claim 1, wherein each set of the clamping devices includes a base that includes a plurality of recesses so as to respectively receive an end of one of the ceramic bars, a plurality of threaded holes defined in the base, a top board mounted on each of the bases and having through holes so that bolts extend through the through holes and are connected in the threaded holes to clamp and position the ceramic bares.

5. The device as claimed in claim 1, wherein two connection rods are connected between the clamping devices to which the two ends of the ceramic bars are connected.

6. The device as claimed in claim 1, wherein each of the ceramic bars is made of metal bars that are treated by nano ceramic glaze and non-stick surface.
